(19) United States
(12) Patent Application Publication
(10) Pub. No.: US 2002/0115756 A1
(43) Pub. Date: Aug. 22, 2002

(54) UV curable hard coatings with UV blocking properties

(76) Inventors: Shi Lin, Petaluma, CA (US); Sunder Ram, Petaluma, CA (US)

Correspondence Address: BURNS DOANE SWECKER & MATHIS L L P, POST OFFICE BOX 1404, ALEXANDRIA, VA, 22313-1404, US

(21) Appl. No.: 09/742,808

(22) Filed: Dec. 19, 2000

(51) Int. Cl. B32B 27/36; C08K 5/34; C08K 3/22

(52) U.S. Cl. 524/100; 428/412; 428/336; 524/430

(57) ABSTRACT

A UV curable composition that contains a UV absorber and that is particularly suitable for coating plastic ophthalmic lenses includes (a) 20% to 80% of a first acrylated aliphatic urethane; (b) 5% to 40% of a monofunctional acrylate; (c) (i) 5% to 60% of a second acrylated aliphatic urethane or (ii) 5% to 60% of a multifunctional acrylate or (iii) a combination (i) and (ii); (d) 1% to 30% of a functionalized colloidal metal oxide; (e) 2% to 15% of an ultraviolet absorber; (f) 1% to 20% of a photoinitiator; and (g) a solvent, wherein the percentages are by weight. The cured composition provides a UV blocking film with improved abrasion and excellent impact resistance as well as protection against environmental and chemical agents. The films have excellent compatibility and adhesion to AR coatings that are applied thereon.

### FIELD OF THE INVENTION

The invention relates to radiation curable coating compositions for plastic articles and particularly to coating compositions for ophthalmic lenses that form coatings with ultraviolet radiation blocking properties. In addition, the coatings exhibit improved abrasion resistance, excellent impact resistance, and compatibility with anti-reflective coatings.

### BACKGROUND OF THE INVENTION

Plastic materials have been used as substitutes for glass lenses in the ophthalmic industry because of their unique properties such as lighter weight, superior shatter resistance, and ease of fabrication. Commercially available plastic ophthalmic lenses may contain diethylene glycol bis(allylcarbonate), polycarbonate, acrylic, polyurethane and other high index materials. Since most plastic ophthalmic lenses are soft and susceptible to scratching, they are commonly coated with a thin polymeric abrasion resistance hard coating.

Anti-reflective (AR) coatings on plastic ophthalmic lenses have been employed to eliminate the light reflection that would otherwise cause images to flicker. AR coatings can be created by vacuum depositing a film of inorganic materials on the hard coating layer of a plastic ophthalmic lens, but the addition of the hard anti-reflective coatings can greatly reduce the impact resistance of plastic lenses. Moreover, the Food and Drug Administration (FDA) requires that plastic ophthalmic lenses must meet a minimum impact strength of 0.2 Joules.

Another concern in the ophthalmic industry is about the effect of UV-A solar radiation (315-380 nm) which is believed to accelerate or cause retinal injuries. The presence of an effective UV screen for the UV-A region in an optical coating would be highly desirable since it would provide protection of the eyes. One possible solution to obtain a high degree of UV absorption in the UV-A region is to incorporate a large amount of UV absorber into hard coating composition. However, this process often leads to loss of adhesion, transparency, or abrasion resistance because of low compatibility of UV absorbers in hard coating compositions. In addition, the presence of UV absorbers make polymerization of UV curable hard coating very difficult due to radiation blocking properties of UV absorbers. It is, therefore, a challenge to have a UV curable hard coating composition that, when cured, has a UV absorbency of 98% or more (2% UV transmittance or less) measured at 380 nm.

In an attempt to improve the impact resistance of plastic lenses, primer coatings that are applied to the plastic lens before the hard coating layer have been used. For instance, U.S. Pat. No. 5,310,577 describes a primer coating composition composed mainly of a blocked polyisocyanate and a polyol that forms a primer layer of a thermoset polyurethane. Similarly, U.S. Pat. No. 5,619,288 describes a method for imparting impact resistance to a plastic ophthalmic lens, that consists of applying a coating of a multifunctional acrylate in a solvent mixture to the back surface of lens and curing the multifunctional acrylate to form an impact resistance primer coat. A hard coat is then applied on top of the primer coat layer to provide abrasion resistance. While the use of a primer coating may improve impact resistance, it also adds an extra step in the fabricating process of fabrication semi-finished lens.

The art is in need of a single UV curable coating composition that is capable of forming hard coatings that have excellent impact resistance and UV radiation blockage.

### SUMMARY OF THE INVENTION

The present invention is based in part on the development of a novel UV curable composition that contains a UV absorber and that is particularly suitable for coating plastic ophthalmic lenses. The cured composition provides excellent UV radiation blockage and impact resistance as well as protection against environmental and chemical agents. In addition, the UV curable compositions are capable of forming films on various substrates; the films have excellent compatibility and adhesion to AR coatings that are applied thereon. No primer coating is required.

In one embodiment, the invention is directed to a radiation curable composition that includes:

(a) 20% to 80% of a first acrylated aliphatic urethane;

(b) 5% to 40% of a monofunctional acrylate;

(c) of (i) 5% to 60% of a second acrylated aliphatic urethane, or (ii) 5% to 60% of a multifunctional acrylate or a combination of (i) and (ii);

(d) 1% to 30% of a functionalized colloidal metal oxide;

(e) 2% to 15% of an ultraviolet absorber;

(f) 1% to 20% of a photoinitiator; and

(g) a solvent, wherein the percentages are by weight.

### DETAILED DESCRIPTION OF THE INVENTION

This invention is directed to a UV curable composition that provides durable UV blocking films with improved abrasion resistance, impact resistance, and excellent adhesion on plastic substrates. When formed on ophthalmic lens surface, the UV blocking film typically has a thickness that ranges from about 4 to 15 μm and preferably from about 6 to 10 μm. The films are also compatible with anti-reflective coatings.

However, prior to describing the invention is further detail, the following terms will be defined:

The term “first acrylated aliphatic urethane” refers to difunctional aliphatic urethanes wherein the functional groups are either acrylolyl or methacryloyl groups. Typically the amount of first acrylated aliphatic urethane present in the radiation curable composition ranges from about 20% to 80% and preferably from about 25% to 60%. Preferred first acrylated aliphatic urethanes include difunctional aliphatic acrylated urethanes such as, for example, those sold under the trademarks CN 962, CN 964, CN 965 and CN 966 from Sartomer Co. and EBECRYL 230 and 270 from UCB Chemicals. Typically the first acrylated aliphatic urethane has an average molecule weight of about 2500 to 4000 Dalton.

The term “monofunctional acrylate” refers to an acrylate monomer that contains only one acryloyl or methacryloyl group. Typically the amount of monofunctional acarylate present in the radiation curable composition ranges from about 5% to 40% and preferably from about 15% to 30%.

The term “second acrylated aliphatic urethane” refers to a trifunctional or higher functional aliphatic urethane wherein the functional groups are either acryloyl or methacryloyl groups or combinations thereof. Typically, when employed the amount of second acrylated aliphatic urethane present in the radiation curable composition ranges from about 5% to 60% and preferably from about 10% to 40%. Preferred second acrylated aliphatic urethanes include highly functional acrylated urethanes such as, for example, CN 968 from Sartomer Company and EBECRYL 8301 and 1290 from UCB Chemicals. Typically, the second acrylates aliphatic urethane has an average molecular weight of about 500 to 1600 Dalton.

The term “multifunctional acrylate” refers to an acrylate monomer or oligomer that contains at least three or more acryloyl or methacryloyl groups or combinations thereof. Typically, when employed the amount of multifunctional acrylate present in the radiation curable composition ranges from about 5% to 60% and preferably from about 20% to 50%. Preferred multifunctional acrylates include pentaerythritol tetraacrylate, dipentaerythritol pentaacrylate, di-trimethylolpropane tetraacrylate, pentaerythritol triacrylate, tris(2-hydroxy ethyl) isocyanurate triacrylate. All of these work to improve cross-linking stability, with concomitant improvements in impact and abrasion resistance. In a preferred embodiment, the multiple functional acrylate comprises a moiety having a hydroxy group and three or more (typically three to six acryloyl groups).

Preferred radiation curable compositions of the present invention comprise at least one of the second acrylated aliphatic urethane or the multifunctional acrylate.

The term “functionalized colloidal metal oxide” refers to metal oxide particles in acrylates or organic solvents. Suitable metal oxides include, for example, silicon oxide. Typically the metal oxide particles have diameters that range from 2 nm to 60 nm and preferably from 5 nm to 50 nm. Suitable colloidal silica include acrylic and methacrylic based silica organols that are commercially available, for example, as HIGHLINK OG108-32 and OG100-31 from Clariant Corporation, MEK-ST and IPA-ST from Nissan Chemical, and FCS 100 from General Electric Company. The HIGHLINK OG108-32 is a liquid suspension of colloidal silica in tripropylene glycol diacrylate. Partially hydrolyzed alkoxysilylacrylates such as acryloxypropyltrimethoxysilane may also be used. Typically, the amount of functionalized colloidal metal oxide present in the radiation curable composition ranges from about 1% to 30% and preferably from about 3% to 20%

The term “photoinitiator” refers to agents that catalyze the polymerization of monomer systems. Suitable photoinitiators include, for example, benzophenone, 1-hydroxycyclohexyl phenyl ketone (methanone), acetophenone, and the like, and mixtures thereof. A mixture of 1-hydroxycyclohexyl phenyl ketone and benzophenone (available under the tradename IRGACURE 500 from Ciba Giegy) is particularly preferred. Typically, the amount of photoinitiator present in the radiation curable composition ranges from about 1% to 20% and preferably from about 5% to 15%.

The term “ultraviolet absorber” or “UV absorber” refers to any substance that absorbs ultraviolet radiant energy, then dissipates the energy. Preferred ultraviolet absorbers include, for example, substitued benzophenones, benzotriazoles and diphenyl acrylates. The amount of UV light blocked by a coating will vary based on the UV absorber concentration and thickness of the coating. An absorbance of about 98% or more (i.e., 2% UV transmittance), measured at 380 nm is preferred for ophthalmic lenses. A preferred UV absorber is 2,2′,4,4′- tetrahydroxy benzophenone available as UVINUL 3050 (BASF Corporation) which provides a UV cut-off of less than 400 nm, and which exhibits excellent solubility, compatibility and stability in the curable coating composition to provide a smooth and clear coated film. UV absorbers are further described in U.S. Pat. Nos. 5,949,518 and 5,959,761 which are both incorporated herein. Typically the amount of UV absorber present in the radiation curable composition ranges from about 2% to 15% and preferably from about 5% to 10%.

The term “dye” refers to any suitable substance that neutralizes the yellow color caused by some UV absorbing materials. UV absorbers capable of blocking the UV-A range (315-380 nm) are in general yellow and imparts an yellow hue to the coating. A feature of the invention is that the addition of the dyes to the polymer composition significantly enhances the optical qualities of the films by producing a color-neutral coating that does not exhibit a hue. Preferred dyes include, for example, blue dyes or a mixture of dyes imparting a blue hue. The dyes must be resistant to chemical degradation, heat and actinic radiation used to cure polymeric compositions. A preferred dye that exhibits these characteristics is 1-[(4-methyl phenyl)amino]-4-hydroxy-9,10-anthracenedione, commercially available as KAYASET Blue A-2R from Nippon Kayaku, Japan. Dyes are further described, for example, in U.S. Pat. 5,949,518 which is incorporated herein. Typically, when employed, the amount of dye present in the radiation curable composition ranges from about 0.001% to 0.5% and preferably from about 0.002% to 0.05%.

The term “flow additive” refers to materials that enhance the rheology of the radiation curable composition. Acrylic or silicone containing surface additives are the preferred flow additives, e.g., BYK 371, BYK 358, both from BYK-Chemie USA, and FC430 from 3M Company. Typically, when employed, the amount of flow additive present in the radiation curable composition ranges from about 0.01% to 3% and preferably from about 0.05% to 0.5%.

The term “substrate” refers to a material which preferably has superior structural and optical properties. Preferred substrate materials include polymers based on allyl diglycol carbonate monomers (such as those available as CR-39 from PPG Industries, Inc., Hartford, Conn.) and polycarbonates such as LEXAN (available from General Electric Co.), acrylic polymers and polyurethanes. Substrates include ophthalmic lenses (including sunglasses). Preferred ophthalmic lenses also include laminated lenses that are fabricated by bonding two lens wafers (i.e., a front wafer and a back wafer) together with a transparent adhesive. As used herein the term “lens” refers to both single integral body and laminated types. Laminated lens wafers are described, for example, in U.S. Pat. Nos. 5,149,181, and 4,645,317 and U.K. Patent Application, GB 2,260,937A, all of which are incorporated herein.

The term “anti-reflection coating” or “AR coating” refers to a substantially transparent multilayer film that is applied to optical systems (e.g., surfaces thereof) to substantially eliminate reflection over a relatively wide portion of the visible spectrum, and thereby increase the transmission of light and reduce surface reflectance. Known anti-reflection coatings include multilayer films comprising alternating high and low refractive index materials (e.g., metal oxides) as described, for instance, in U.S. Pat. Nos. 3,432,225, 3,565,509, 4,022,947, and 5,332,618, all of which are incorporated herein. AR coatings can also employ one or more electrically conductive high and/or electrically conductive low refractive index layers which are further described in U.S. Pat. Nos. 5,719,705 which is incorporated herein by reference. The thickness of the AR coating will depend on the thickness of each individual layer in the multilayer film and the total number of layers in the multilayer film. Preferably, the AR coating for the ophthalmic lens that is formed on the impact resistance UV cured hard coating has about 3 to about 12 layers. Preferably, the AR coating is about 100 to about 750 nm thick. For use with ophthalmic lenses, the AR coating is preferably about 220 to about 500 nm thick. Inorganic anti-reflective coatings can be single-layer systems, but more generally are multi-layer anti-reflective stacks deposited by vacuum evaporation, deposition, sputtering, ion plating, and/or ion bean assisted methods.

The term “solvent” is meant to include a single solvent or a mixture of solvents that dissolves the first acrylated aliphatic urethane, monofunctional acrylate, the second acrylated urethane and/or multifunctional acrylated and photoinitiators so that the coating composition can be readily applied. Particularly preferred solvents include, for example, methyl ethyl ketone, acetone, methyl isobutyl ketone, methyl propyl ketone, cyclohexanone, cyclopentanone, butyrolactone, methanol, ethanol, isopropanol, butanol, tetrahydrofuran, N-methyl pyrrolidone, tetrahydrofurfural alcohol, and mixtures thereof. Ketones are particularly preferred because they exhibit excellent solubility of the first and second acrylated aliphatic urethanes and photoinitiator as well.

The amount of solvent used will depend on, among other things, the particularly components employed to formulate the coating composition, the temperature of the coating composition, the coating thickness, and the coating technique to be used. Typically, the solvent will comprise from about 30% to 85% of the radiation curable coating composition. For spin coating applications, the solvent will preferably range from about 40% to 75% of the radiation curable coating composition.

### FORMULATION OF COATING COMPOSITION

The radiation curable coating composition is preferably formulated by blending together the (i) first acrylated aliphatic urethane, (ii) monofunctional acrylate, (iii) second acrylated aliphatic urethane and/or multifunctional acrylate, (iv) functionalized colloidal metal oxide, (v) UV absorber, (vi) dye and (vii) photoinitiator in a suitable organic solvent. Optional components such as flow additive, flatting agent and/or surface active agents can also be added at this stage.

The curable coating compositions can be applied to substrates by conventional coating methods such as, for example, spinning, dipping, spraying and the like. No surface pretreatment of the substrate or formation of an adhesive or primer layer on the substrate prior to coating is required. Spin coating is particularly preferred because it readily creates a uniform film which when cured is relatively defect free. The thickness of the coating of curable coating composition that is applied will depend on the particular substrate and application. In the case of ophthalmic plastic lenses the thickness of the film should be sufficient so that when the composition is cured, the impact resistant layer will have a final thickness that ranges from about 1 to about 15 μm and preferably from about 1.5 to about 8 μm. Thicker protective layers can lead to crazing and other defects over time, however, thinner layers often do not provide enough surface material to be resistant. Additionally, it is often advantageous to have a coating that is thick enough to cover minor blemishes on the surface of the lens.

The curable coating compositions can be cured by radiation, e.g., UV radiation. Sources of UV radiation include, for example, plasma arc discharges, mercury vapor lamps, etc. A preferred source of UV irradiation is a Fusion 300 watt/in H lamp.

Finally, an anti-reflective coating can be formed on the impact resistant layer, if desired. No surface pretreatment or formation of an adhesive or primer layer on the protective layer is required.

### EXPERIMENTAL

Table 1 sets forth the coating composition formulations that were coated on fabricated CR-39 from SOLA Optical USA, Petaluma, CA. The lenses had a silicone hard coating coated on the front (i.e., convex) side. Polycarbonate lenses were also tested.

TABLE 1

| Formu- | CN | CN 965 | CN | | | HA- | | IRGUCURE | | HIGHLINK | HIGHLINK | BYK | Blue | UVINUL |
|---|---|---|---|---|---|---|---|---|---|---|---|---|---|---|
| lation No. | 962 | H60 | 968 | HEMA | MIBK | 174 | DPHPA | 500 | PETA | OG 100-31 | OG 108-32 | 371 | Dye | 3050 |
| 1 | | 60 | 10 | 30 | 100 | | | 10 | | | | | | 8 |
| 2 | 60 | | 10 | 30 | 100 | | | 10 | | | | | | 8 |
| 3 | 50 | | 20 | 30 | 100 | | | 10 | | | | | | 8 |
| 4 | 45 | | | 25 | 110 | | 30 | 10 | | | | | | 8 |
| 5 | 45 | | | 25 | 110 | 6 | 30 | 10 | | | | | | 8 |
| 6 | 25 | | | 25 | 121 | | 20 | 10 | 30 | | | | 0.033 | 8 |
| 7 | 25 | | | 25 | 120 | | 20 | 10 | 30 | | 10 | | 0.036 | 8 |
| 8 | 45 | | | 18 | 121 | | 30 | 10 | | 10 | | 0.242 | 0.036 | 8 |
| 9 | 45 | | | 25 | 100.6 | | 30 | 10 | | | 5 | 0.224 | 0.034 | 8 |

Formulation 1 was prepated by initially dissolving the CN 965, CN 968, and hydroxyethyl metharcylate (HEMA) in methyl isobutyl ketone (MBK) and mixing for 2 hours. Thereafter, IRGACURE 500 and UNIVUL 3050 were added and the mixture was mixed for another 30 minutes.

For formulations 2 and 3, the same process as number 1 was employed except that CN 962 was used instead of CN 965.

Formulation 4 was prepared by initially dissolving the CN 962, dipentaerythritol pentaacrylate (DPHPA) and HEMA in MIBK and mixing for 2 hours. Thereafter, the IRGACURE 500 and IVINUL 3050 were added and the mixture was mixed for another 30 minutes.

For formulation 5, methacryloxpropyltrimethoxsilane (available as A-174 from Witco Corp.)was hydrolyzed by mixing 50 parts of it with 7.25 parts of deionized water 0.028 parts of concentrated hydrochloric acid for 20 hours at ambient temperature and then removing the volatiles with a rotary evaporator. The resulting hydrolzate is designated HA-174. The HA-174 was then mixed with a resin solution prepared in accordance with Example 4 for two hours.

Formulation 6

was prepared by initially dissolving the CN 962, DPHPA, pentaerythritol triacrylate (PETA) and HEMA in MIBK and mixing for 2 hours. Thereafter, the IRGACURE 500 and UVINUL 3050 were added and the mixture was mixed for another 30 minutes. Then, the blue dye (KAYASET BLUE A-2R) was added to resin solution and stirred for 30 minutes.

For formation 7, the same process as number 6 was employed except that HIHGLINK OG 108-32 was also used and initially dissolved in the MIBK.

Formulation 8 was prepared by initially dissolving the CN 962, DPHPA, HEMA, and HIGHLINK OG 100-31 in MIBK and mixing for 2 hours. Thereafter, the IRGACURE 500 and UVINUL 3050 were added and the mixture was mixed for another 30 minutes before the BYK 371 and KAYASET BLUE A-2R blue dye were added to the resin solution and stirred form another 30 minutes.

For formulation 9, the same process as number 8 was employed, but HIGHLINK OG 108-32 was used instead of HIGHLINK OG- 100-31.

The back (concave) side of 9 sets of the CR-39 semi-finished lenses were initially surfaced and polished to a 2.0 mm nominal center thickness. After being wiped clean with isopropanol, each lens back surface was coated with one of formulations 1- 9 from Table 1. Specifically, either a 6.7 or 7 micron thick coating was applied on the back side by spin coating and then cured. In some cases, antireflection (AR) coatings were also applied to both the front and back surfaces of the lenses using a vacuum deposition process to deposit a 5 layer film comprising alternating layers of titanium oxide and silicon oxide, with silicon oxide being the first, third, and fifth layers. Finally, a tenth set of lenses made from polycarbonate was also similarly surfaced and polished and was coated with 7 micron thick coatings of formulation 8. AR coatings were applied to some lenses as well.

The lenses without AR coatings were subjected to adhesion, hot water resistance, weathering, and impact tests. The spectrophotometric transmittance of each lens at 380 nm was also measured. Some lenses with AR coating were also subject to the impact test. (The test parameters are described herein.) As is apparent from the results shown in Table 2, all of the lenses demonstrated good adhesion and impact strength. The lenses also provided excellent UV-A blockage of greater than 98% (i.e., transmittance of less than 2%). By comparison, CR-39 lenses that are similarly surfaced and polished but which are not coated with the inventive coating composition exhibit a UV transmittance of about 43% at 380 nm.

TABLE 2

| Coating | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| Transmittance | 0.54 | 0.56 | <2 | <2 | <2 | <2 | <2 | <2 | <2 | <2 |
| Adhesiveness | 100 | 100 | 100 | 100 | 100 | 100 | 100 | 100 | 100 | 100 |
| Hot water resistance | 100 | 100 | 100 | 100 | 100 | 100 | 100 | 100 | 100 | 100 |
| Weathering test, 4 weeks | — | — | pass | pass | — | pass | pass | pass | — | pass |
| Impact (w/o AR coating) | 2.0 | 2.0 | 1.2 | 1.3 | 1.4 | 0.6 | 0.5 | 1.0 | 0.6 | >2.0 |
| (Joules) | | | | | | | | | | |
| Impact (w/AR coating) | — | — | 1.3 | 0.7 | — | 0.4 | 0.4 | 1.0 | 0.5 | >2.0 |

### Adhesion Test

The cross-cut tape test, where 6 parallel lines each in two perpendicularly crossing directions are cut with a six blade cutter was employed. The lines are cut at fixed intervals of approximately 1 mm, on the surface of the coating of a given sample to produce a total of 49 squares. Thereafter, adhesive cellophane tape is applied to the cut squares, the tape is peeled, and the squares on which the coat film are counted. The adhesion is measured by the number of squares remaining.

### Impact Test

The impact resistance of the coated lenses were measured using an impact tester from American Optical Corporation based on U.S. Pat. No. 3,896,657. The tester utilizes a 5/8 in. (1.6 cm) diameter stainless steel ball supported by a magnet vertically above the anvil on which a lens is mounted at a fixed distance from the ball. The ball can be accelerated by different velocities using compressed air to allow for variable impact energy of the ball against the lens being tested when the ball is aimed to strike at the center of the lens. The results of this test are measured in Joules.

### Hot Water Resistance Test

A sample was placed in boiling water for totally three hours. The adhesion test was applied to the sample each hour.

### Weathering Test

Samples were placed outdoors for four weeks. The adhesion and micro-cracking of the coating are checked every two days.

Finally, coating formulation 1 or 2 of different thicknesses was coated onto CR-39 lenses in the manner described above. After curing the coatings, the transmittance of the lenses of radiation having a wavelength of 380 nm was measured. As evidenced by the data set forth in Table 3, thicker coatings afford greater UV absorption. For these formulations which contain 8 parts of the UV absorber UVINUL, the coating thickness should be about 6 microns of more. It should be noted that the using higher amounts of UV absorber will also increase UV absorption.

TABLE 3

| | Coating Thickness | |
|---|---|---|
| Formulation | (μm) | Transmittance, %, at 380 nm |
| 1 | 6.7 | 0.54 |
| 1 | 5.7 | 1.94 |
| 1 | 5.5 | 2.30 |
| 1 | 5.3 | 3.35 |
| 2 | 6.7 | 0.56 |
| 2 | 6.0 | 1.50 |
| 2 | 5.7 | 1.83 |
| 2 | 3.4 | 5.89 |

Although only preferred embodiments of the invention are specifically disclosed and described above, it will be appreciated that many modifications and variations of the present invention are possible in light of the above teachings and within the purview of the appended claims without departing from the spirit and intended scope of the invention.

What is claimed is:

1. A radiation curable composition that comprises:
(a) 20% to 80% of a first acrylated aliphatic urethane;
(b) 5% to 40% of a monofunctional acrylate;
(c) at least one of (i) 5% to 60% of a second acrylated aliphatic urethane or (ii) 5% to 60% of a multifunctional acrylate or combinations of (i) and (ii);
(d) 1% to 30% of a functionalized colloidal metal oxide;
(e) 2% to 15% of an ultraviolet absorber;
(f) 1% to 20% of a photoinitiator; and
(g) a solvent, wherein the percentages are by weight.

2. The radiation curable composition of claim 1 wherein the ultraviolet absorber is selected from the group consisting of benzophenones, benzotriazoles, diphenyl acrylates, and mixtures thereof.

3. The radiation curable composition of claim 1 wherein the ultraviolet absorber comprises 2,2′, 4,4′- tetrahydroxy benzophenone.

4. The radiation curable composition of claim 1 wherein the first acrylated aliphatic urethane is a difunctional acrylated aliphatic urethane.

5. The radiation curable composition of claim 1 wherein the first acrylated aliphatic urethane has a molecular weight of between 2500 to 4000 Dalton.

6. The radiation curable composition of claim 1 wherein the second acrylated aliphatic urethane contains 3 or more polymerizable unsaturated moieties per molecule.

7. The radiation curable composition of claim 1 wherein the second acrylated aliphatic urethane has a molecular weight of between 500 to 1600 Dalton.

8. The radiation curable composition of claim 1 wherein the multifunctional acrylate comprises a moiety having a hydroxy group and three or more acryloyl groups.

9. The radiation curable composition of claim 1 further comprising a flow additive.

10. A transparent plastic article which comprises:
(a) a substrate; and
(b) a hard coating on a surface of said substrate wherein the coating is formed by radiation curing a composition that comprises:
(i) 20% to 80% of a first acrylated aliphatic urethane;
(ii) 5% to 40% of a monofunctional acrylate;
(iii) (1) 5% to 60% of a second acrylated aliphatic urethane or (2) 5 % to 60% of a multifunctional acrylate or a combination of (i) and (ii);
(iv) 1% to 3 0% of a functionalized colloidal metal oxide;
(v) 2% to 15% of an ultraviolet absorber;
(vi) 1% to 20% of a photoinitiator; and
(vii) a solvent, wherein the percentages are by weight.

11. The transparent article of claim 10 wherein the ultraviolet absorber is selected from the group consisting of benzophenones, benzotriazoles, diphenyl acrylates, and mixtures thereof.

12. The transparent article of claim 10 wherein the ultraviolet absorber comprises 2,2′, 4,4′- tetrahydroxy benzophenone.

13. The transparent article of claim 10 wherein the first acrylated aliphatic urethane is a difunctional acrylated aliphatic urethane.

14. The transparent article of claim 10 wherein the first acrylated aliphatic urethane has a molecular weight of between 500 to 1600 Dalton.

15. The transparent article of claim 10 wherein the second acrylated aliphatic urethane contains 3 or more polymerizable unsaturated moieties per molecule.

16. The transparent article of claim 10 wherein the second acrylated aliphatic urethane has a molecular weight of between 500 to 1600 Dalton.

17. The transparent article of claim 10 wherein the multifunctional acrylate comprises a moiety having a hydroxy group and three or more acryloyl groups.

18. The transparent article of claim 10 wherein the composition further comprises a flow additive.

19. The transparent article of claim 10 wherein the substrate is an ophthalmic lens.

20. The transparent article of claim 10 wherein the hard coating has a thickness of about 6 μm to 15 μm.

21. The transparent article of claim 10 wherein the ophthalmic lens is made of diethylene glycol bis(allyl carbonate).
